(19) United States
(12) Patent Application Publication
(10) Pub. No.: US 2010/0088965 A1
(43) Pub. Date: Apr. 15, 2010

(54) OVERHEAD DOOR WITH DUAL TRACK MOUNTING

(75) Inventors: Donald L. Metz, Kirkville, NY (US); David Martini, Liverpool, NY (US)

Correspondence Address: MARJAMA MULDOON BLASIAK & SULLIVAN LLP, 250 SOUTH CLINTON STREET, SUITE 300, SYRACUSE, NY, 13202, US

(73) Assignee: DL Manufacturing, North Syracuse, NY (US)

(21) Appl. No.: 12/444,506

(22) PCT Filed: Oct. 6, 2006
(86) PCT No.: PCT/US06/39321

§ 371 Date: Dec. 14, 2009

(51) Int. Cl. E05D 15/16; E05D 15/00

(52) U.S. Cl. 49/427; 49/404; 16/96 R; 16/91

(57) ABSTRACT

An overhead door, which is adapted to have its primary tracking members temporarily disengaged from their primary track when impacted by a substantial force when in the closed or partially closed position, is adapted to smoothly transition from its vertical, closed position to a non-vertical, open position by the use of second tracking members and track which come into use as the door panels transition from a vertical orientation to a non-vertical orientation. The impact caused disengagement feature is therefore effective without interference from the second tracking members, but progressively gives way to the second tracking members and track as the door is raised toward an open position.

### FIELD OF THE INVENTION

This invention relates generally to overhead doors and, more particularly, to a door with two separate track systems which allow for an effective transition from a breakaway mode when in the down position to the stored mode when in the raised position.

Overhead doors are used to occlude openings in structures such as warehouses, factories, and other commercial establishments. Typically such a door is comprised of a series of panels hinged together and moveable between a doorway blocking position to an overhead storing position. In the stored position, the door may be disposed in a vertical, horizontal, or oblique angle position. For either of the horizontal or oblique angle dispositions there is generally provided a curved track to transition from the vertical closed position to the non-vertical stored disposition.

Overhead doors used at loading docks are often subject to impacts from forklifts, other loading devices, and freight. Such impacts often cause damage to an overhead door and sometimes to the building structure supporting the door. Accordingly, various types of “breakaway” devices have been designed to allow for the door to be temporarily disengaged from its vertical track when impacted by a substantial force. One such assembly, described in U.S. Pat. No. 6,988,528, having common inventorship with the present invention, provides for the use of brushes on the side edges of the door, with the brushes being slideably disposed in a track and disengageable therefrom upon impact. Another apparatus, shown in U.S. Pat. No. 5,927,368, assigned to HPD International, Inc., provides a plurality of plungers extending outwardly from the door's edges to engage a groove of a track, with the spring biased plungers being disengaged from the track when the door's impacted. Another, U.S. Pat. No. 6,321,822, assigned to Rite-Elite Holding Corporation, includes a roller and track combination that is moveable relative to each other upon application of a breakaway force to the door.

In each of the above systems, a problem arises when the door is raised and the breakaway apparatus is caused to move along a curved portion of the track to move the door to the stored position. That is, because the mounting structure is designed to provide the breakaway feature, it is not so flexible as to be easily made to move through the curved portion of the track without complications such as frictional loading or leaving the track.

### SUMMARY OF THE INVENTION

Briefly, in accordance with one aspect of the invention, a secondary track is provided above the doorway opening to accommodate a secondary tracking mechanism mounted on the door, such that when the door is in the down position, only the primary, disengageable, tracking mechanism is engaged in its primary track, but as the door is raised, the secondary tracking mechanism is fed into the secondary track, while at the same time the primary tracking mechanism is exiting its track. In this way, a smooth transition is made between the primary and secondary tracking mechanisms as the door is moved from the closed to the open position.

In accordance with another aspect of the invention, the secondary tracking mechanism comprises a plurality of rollers that are mounted on the outer side of the door and in a location which is inboard from the outer edge of the primary tracking member such that they do not interfere with the movement of the door during a disengagement process as caused by an impact.

In the drawings as hereinafter described, a preferred embodiment is depicted; however, various other modifications and alternate constructions can be made thereto without departing from the spirit and scope of the invention.

### BRIEF DESCRIPTION OF THE DRAWINGS

FIG. 1 is a perspective view of an overhead door with the present invention incorporated therein.

FIG. 2 is a top partial view of one side of the door as seen along lines 2-2 of FIG. 1.

FIG. 3 is a perspective top view thereof of the other side of the door.

FIG. 4a-4c are illustrative of various types of door mounting arrangements for which the present invention is applicable.

### DESCRIPTION OF THE PREFERRED EMBODIMENT

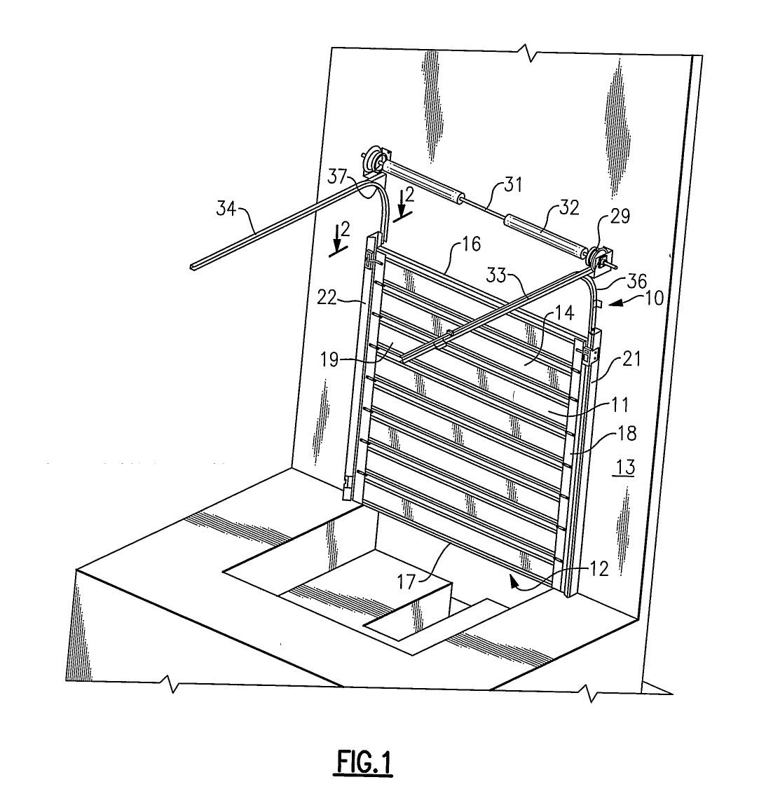

Referring now to FIG. 1, the invention is shown generally at 10 as applied to an overhead door 11 which is mounted in a vertically orientated, closed position to close an opening 12 in a building side wall 13. The door 11 is comprised of a plurality of panels 14 that are hingedly connected at their edges, such that the door 11 is flexible to permit its movement around a curved track as it is moved to an open position. The door 11 has upper and lower edges 16 and 17 and side edges 18 and 19.

Mounted to the wall 13, on either side of the door 11 are vertical support members 21 and 22. The door 11 is supportably mounted within the vertical support members 21 and 22 in a manner which permits the door 11 to be temporarily disengaged from its mounting position when impacted by a substantial force as shown and described in U.S. Pat. No. 6,988,528, having common inventorship herewith, and incorporated herein by reference.

As shown in FIG. 2, a primary track member 23 is mounted to the vertical support member 22 and includes a U-shaped track opening 24. Attached to the door side edge 19 is a laterally extending brush 26, which extends the vertical length of the door and projects into the U-shaped track opening 24 at its end 25. The brush 26 is properly sized with respect to the track opening 24 such that the brush 26 can freely move upwardly and downwardly within the track opening 24 while, at the same time, providing a sealing relationship between the brush 26 and the track opening 24. Further, as described in the above referenced patent, the brush 26 is sufficiently flexible such that when the door 11 is impacted on either side thereof by a sufficient force, the brush 26 can be caused to be dislodged from its position within the track opening 24 so as to permit the doors outward or inward movement to prevent significant damage to the door.

Considering now the manner and structure for moving the door 11 to an open position, a lift bracket 27 is attached to the door side edge 19 at a point near the bottom of the door 11, and a cable 28 is secured to the lift bracket 27. The cable 28 passes upwardly to be wound around a pulley 29 mounted on a shaft 31 (see FIG. 1). A torsion spring 32 mounted to the shaft 31 biases the rotation of the shaft 31 such that the door 11 is biased to move in the upward position.

It should be recognized that other mechanisms for opening and closing the door 11 can be used while remaining within the scope of the invention. For example, rather than the pulley 29 and spring 32, the cable 28 may be secured to a counterweight to provide the biasing effect.

Having discussed the position of the door in the closed position, it is necessary to consider its position when moved to an open condition. As shown in FIG. 1, a pair of horizontally disposed rails or tracks 33 and 34 are provided to guide the movement of the door 11 to an open/storage position. Also, in order to bridge the movement of the door 11 between the vertical primary track members 23 and the tracks 33 and 34, arcuate track members 36 and 37 are provided as shown.

The applicants have found that when a door with side brushes mounted in vertical track openings is caused to move along an arcuate path, such as the arcuate track members 36 and 37, the brushes are likely to come out of the track such that the door is no longer properly supported. The same problem is seen as occurring with other, non-brush, mounted arrangements such as those discussed hereinabove with respect to the prior art. Accordingly, the need was seen for a disengageable type of overhead door which, when moved to the open/stored position, will ensure that the door remains in a properly supported condition. The present invention accomplishes this in a simple and effective manner with the structure which will now be described.

As will be seen in FIG. 3, rather than providing a continuous track which allows movement along the track from a closed door to an open door condition, a secondary track 38 (the portion shown being a vertical and linear portion of the arcuate track member 36) is provided in a position which is separate from and not aligned with the U-shaped track opening 24. As will be seen in FIG. 2, the secondary track member 38 is mounted to the vertical support member 22 by a bracket 39.

Attached to the door outer side 41 is a plurality of secondary tracking mechanisms 42 (that shown being one mounted near the top of the door) which include a mounting bracket 43, a shaft 44 and a roller or a wheel 46. Preferably, such a secondary tracking mechanism 42 is attached to each side of each of the panels 14. As will be seen in FIGS. 2 and 3, when the door 11 is in the closed position, the secondary tracking mechanism 42 which is nearest the top of the door, is engaged within the secondary track member 38. As the door 11 is moved upwardly from the closed position, the secondary tracking mechanisms 42 progressively move into the secondary track member 38, while at the same time, the brush 26 progressively exits from the U-shaped track opening 24 such that when the door is in the fully opened position, the brush is entirely outside of the U-shaped track opening 24 and free of engagement with any other structure, while the secondary tracking mechanisms 42 are all within the secondary track member 38. The secondary track member 38 therefore comprises the vertical, linear portion of the arcuate member 36, the arcuate portion of the arcuate track member 36 and the horizontal track 33. When the door 11 is in the fully opened position, the secondary tracking mechanisms 32 should all be located within the tracks 33 and 34.

It should be recognized that, in order for the disengageable feature of the door (i.e. the tracking mechanism that is effective during periods in which the door is fully closed or in the partially closed position), to properly function, it is necessary that the secondary tracking mechanism be so placed so as to not interfere with the disengaging function. This is accomplished with the present invention by locating the secondary tracking mechanism 42 on the outer side of the door and in a position where its wheel is disposed transversely inwardly (i.e. toward the center of the door) from the outer edge of the brush 26, as shown in FIG. 2. Thus, when the door is in the fully closed position, only the secondary tracking mechanism 42, with its wheel 46, is engaged with the secondary track member, and all of the other wheels 46 of the other secondary tracking mechanism are disengaged and free to move. Accordingly, almost the entire length of the door is free to be disengaged from the primary track 23, and only at the very top of the door 11 will the secondary tracking mechanism 42 be prevented from being disengaged because of its having a wheel 46 engaged in the secondary track member 38.

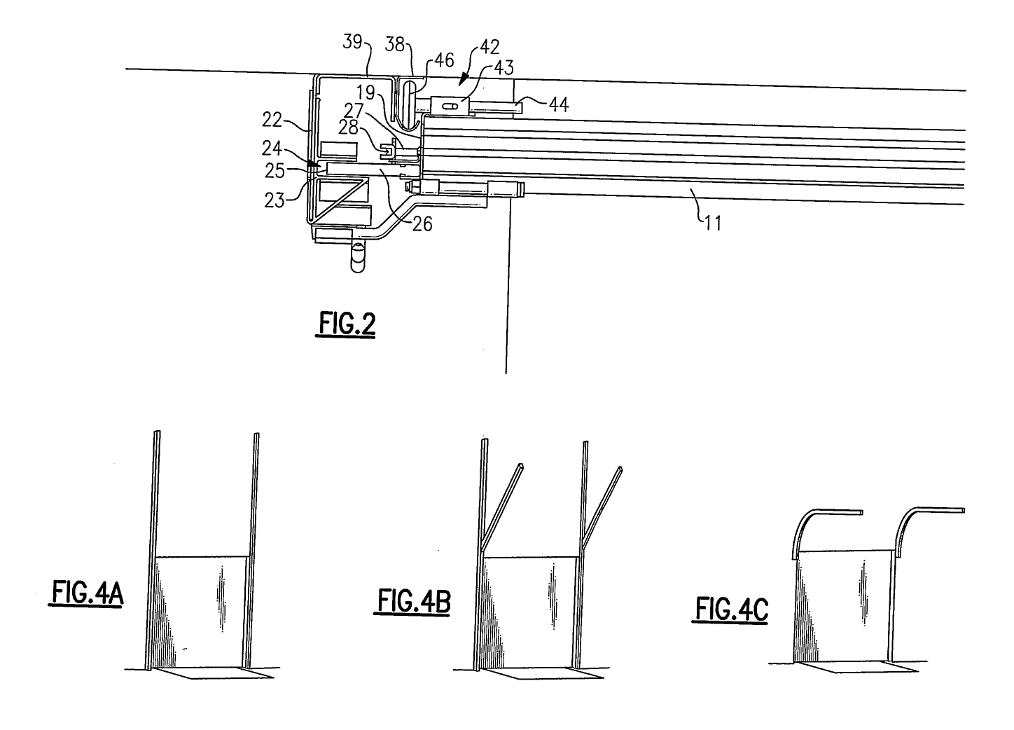

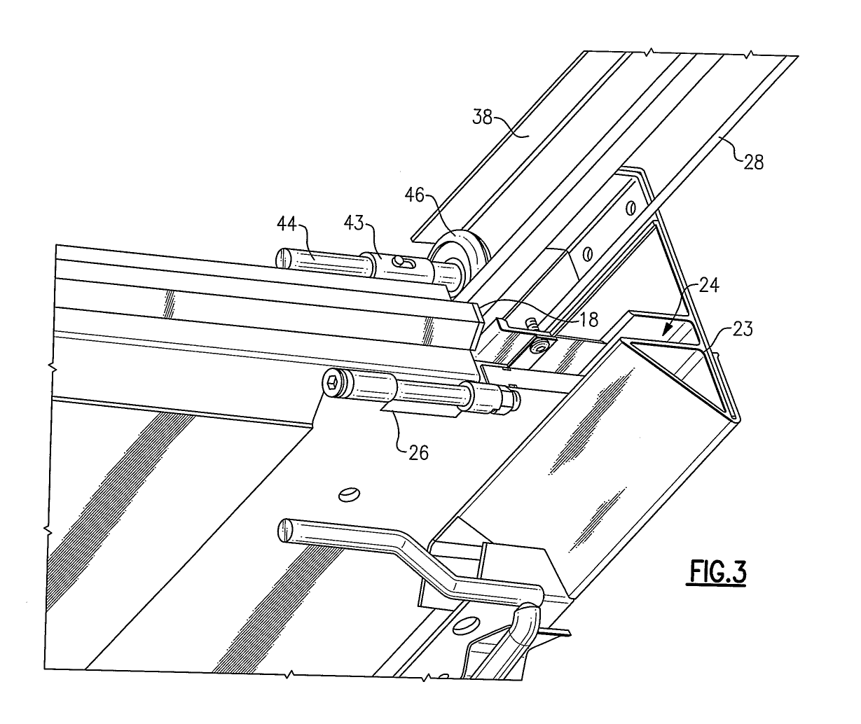

Referring now to FIGS. 4a-4c, there are shown various arrangements for storage of an overhead door. The arrangement shown in FIG. 4a is that which is described hereinabove and is known as a high-lift arrangement. FIG. 4b is a variation thereof wherein the support tracks are disposed at an oblique angle to the vertical. Although the oblique members are shown as disposed at a sharp angle with the vertical members, they may also include an arcuate section between the oblique and vertical members. In either case, the problem of the tracking members moving from the vertical to the oblique members as discussed hereinabove, remains. Accordingly, the present invention is very suitable for this arrangement as well.

The FIG. 4c arrangement, which is known as a true vertical arrangement, does not have the problem of the tracking member transitioning between members as discussed hereinabove since the tracking member can remain in the same track for both the closed door and open door position. However, the present invention may be used, if desired.

We claim:

1. An overhead door assembly for mounting a door in an opening defined by structural side members and a top member, said door being adapted to be raised from a downward, closed position to an upward open position, comprising:
at least one panel having side edges and separate, first and second tracking members attached thereto;
a first track attached to each of said structural side members for slideably receiving said first tracking member therein so as to guide said door in its upward and downward movement while allowing disengagement of said first tracking member from said first track upon the application of a force against said panel; and
a second track mounted in an elevated position above said opening for receiving said second tracking member therein so as to guide said door in its movement to positions above said opening.

2. An overhead door assembly as set forth in claim 1 wherein said door includes a plurality of panels, with each panel having first and second tracking members.

3. An overhead door assembly as set forth in claim 2 wherein, when the door is moved from the closed position toward an open position, the first and second tracks are so disposed that, as the first tracking members are leaving the first track, the second tracking members are entering the second track.

4. An overhead door assembly as set forth in claim 3 wherein, when the door is in the filly closed position, there is one second tracking member disposed within said second track member.

5. An overhead door assembly as set forth in claim 1 wherein said second tracking member is located on an outer side of the door.

6. An overhead door assembly as set forth in claim 1 wherein said second tracking member comprises a wheel.

7. An overhead door assembly as set forth in claim 6 wherein the wheel is located inboard from an outer edge of said first tracking member such that it does not interfere with the movement of the door during the disengagement process as caused by an impact.

8. An overhead door assembly as set forth in claim 1 wherein said first tracking member comprises a brush.

9. An overhead door assembly as set forth in claim 6 wherein said wheel is disposed outboard of said panel side edge.

10. A method of mounting an overhead door of the type having side edges and a plurality of hingedly interconnected panels comprises the steps of:
providing a first track disposed in a substantially vertical orientation near said door side edges;
providing a first tracking member near each side edge of the door for moveably engaging said first track and being disengageable therefrom upon being substantially impacted by a force when in a closed or partially closed position;
providing a second track in an elevated position above said first track for storage of the door when in an open position; and
providing a second tracking member attached near each side edge of the door for moveably engaging said second track when the door is moved to an open position.

11. A method as set forth in claim 10 wherein each panel is provided with first and second tracking members.

12. A method as set forth in claim 10 wherein, when the door is moved from the closed position toward an open position, the first and second tracks are so disposed that, as the first tracking members are leaving the first track, the second tracking members are entering the second track.

13. A method as set forth in claim 12 wherein, when the door is in the fully closed position, there is one second tracking member disposed within said second track.

14. A method as set forth in claim 10 wherein said second tracking member is located on an outer side of the door.

15. A method as set forth in claim 10 wherein said second tracking member comprise a wheel.

16. A method as set forth in claim 15 wherein the second tracking member is located inboard from an outer edge of said first tracking member such that it does not interfere with the movement of the door during the disengagement process as caused by an impact.

17. A method as set forth in claim 10 wherein said first tracking member comprises a brush.

18. A method as set forth in claim 17 wherein said wheel is disposed outboard of said door side edge.
